(19) United States
(12) Patent Application Publication
(10) Pub. No.: US 2010/0136944 A1
(43) Pub. Date: Jun. 3, 2010

(54) METHOD AND SYSTEM FOR PERFORMING A TASK UPON DETECTION OF A VEHICLE TRIGGER

(76) Inventors: Tom Taylor, Atlanta, GA (US); Dane Dickie, Atlanta, GA (US)

Correspondence Address: HUGHES TELEMATICS, INC., 2002 Summit Blvd, Suite 1800, ATLANTA, GA, 30319, US

(21) Appl. No.: 12/626,285

(22) Filed: Nov. 25, 2009

Related U.S. Application Data
(60) Provisional application No. 61/117,784, filed on Nov. 25, 2008.

(51) Int. Cl. H04M 11/04; G08B 1/08; G06F 7/00; G01S 19/13; G06F 17/30

(52) U.S. Cl. 455/404.1; 340/539.11; 701/36; 701/29; 342/357.09; 701/33; 707/769; 707/E17.014

(57) ABSTRACT

A triggering event causes a telematics device to transmit information to a user device. Or, the telematics device may perform a task in response to determining that a trigger even occurred. The user device generates an alert in response to the transmitted information producing the alert, for example, graphically, audibly, textually, or using a combination thereof. A triggering event may be the attaining of a certain location of the TCU along a predetermined commute route. Or, the detection of force exerted on a vehicle, possibly indicating attempted theft of the vehicle. Upon the triggering event occurring, the TCU can formulate a message, for example calculate time of arrival based on the traffic conditions and speed limits along the commute route. The TCU may also transmit its location information to another device, such as the user device, or a device coupled thereto, and the other device formulates the message.

### CROSS REFERENCE TO RELATED APPLICATION

The present application claims priority under 35 U.S.C. 119(e) to U.S. Provisional Patent Application No. 61/117,784 filed on Nov. 25, 2008, by Dickie, entitled “Method and system for performing a task upon detection of a trigger in a vehicle,” which the present application incorporates by reference in its entirety.

### SUMMARY

Provided are methods and systems for vehicle interaction utilizing a telematics control unit (“TCU”) device coupled to a vehicle (this application may also refer to a TCU as a vehicle control unit, or “VCU”). A user may associate a trigger event with a corresponding stimulus, or a task. The user may select the stimulus and the trigger as the same action. A user may perform the association of a trigger with a task, or a stimulus, using a computer device located remotely from a vehicle in which the task, or stimulus, occurs. The computer device could be a personal computer, a telephony device, a wireless device that facilitates telephony and data services, or other electronic devices that can couple to a communications network and transmit and receive electronic messages thereto and therefrom, respectively.

Typically, the trigger will occur in a vehicle that contains a corresponding TCU. The TCU determines that a trigger event has occurred and transmits an electronic trigger occurrence message to a central computer indicating that the trigger occurred. When the centralized computer (which may be referred to as a server) receives the message transmitted from the TCU, it performs some action, or causes another device to perform an action. For example, the centralized server may perform a table lookup based on information contained in the trigger occurrence message. Then, after performing the table lookup and retrieving resultant information from the table lookup process, the central server may include the result of the table lookup in an action message that it (the central computer server) causes to be transmitted back to the TCU that originated the trigger occurrence message. In addition, or alternatively, the centrally located server may transmit the action message to an electronic device remote from the vehicle that contains the TCU that originated the trigger occurrence message, or to a device that may be collocated with the vehicle but that is not fixed to, directly coupled to, or considered part of, the vehicle.

The action message may instruct a receiving electronic device to perform an action such as a stimulus, which may include an alert, an indication, or generate similar sensory energy that informs someone that a trigger occurred. Examples of a stimulus action include an auditory alarm and a visual indicator such as illumination of a light or displaying an icon on a screen. Other forms of stimulus include vibration of an electronic device such as a smart phone or other personal electronic device.

Other actions may include evaluating information received in a trigger occurrence message, obtaining, or deriving, information based on the evaluation of the trigger occurrence message, and sending the obtained, or derived, information, to a user's electronic device, either collocated at a vehicle from which the trigger occurrence message originated, or to an electronic device remote from the vehicle from which the trigger occurrence message originated. The information could be obtained, or derived, by performing a table lookup based on information contained in a trigger occurrence message.

A user can use a first electronic device to configure an action to occur at a second electronic device upon the occurrence of a trigger. For example, a user may use a personal computer located at his home or office and coupled to the internet to configure a central computer system that also communicates with the internet, or similar communications network, and with the TCU, to initiate the sending of an e-mail message, SMS message, web page, or similar message to a personal mobile wireless communication device such as a cell phone. The trigger could occur when the TCU crosses a geographical boundary previously programmed into the TCU by the remote personal computer. As the TCU compares its current GPS coordinates to the predetermined geographical boundary programmed into it, it sends a trigger occurrence message to the central computer. Upon receiving the trigger occurrence message, the central computer may perform a table lookup to determine how to act upon the received trigger occurrence message. Based on an identifier contained in the trigger occurrence message the central computer can look up and determine what type of message to send and what electronic device identifier to use in sending the message. The identifier in the trigger occurrence message may correspond to a unique identifier of the TCU, or may be an identifier stored in the TCU that corresponds to a given user, or subscriber, of telematics services, for example.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary vehicle telematics unit;

FIG. 2 is an exemplary network environment;

FIG. 3 is an exemplary operating environment;

FIG. 4 is an exemplary method of operation;

FIG. 5 is an exemplary method of operation;

FIG. 6 is an exemplary method of operation;

FIG. 7 is an exemplary method of operation;

FIG. 8 is an exemplary apparatus; and

FIG. 9 is an exemplary system.

### DETAILED DESCRIPTION

Before the present methods and systems are disclosed and described, it is to be understood that the methods and systems are not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

Provided herein are methods and systems that allow customization of vehicle features. Triggers can be used to initiate a pre-defined task. Triggers can be, for example, one or more of location based triggers, a user initiated triggers, and/or vehicle condition triggers. The task can be presenting a stimulus. The stimulus can be, for example, one or more of, an audio stimulus, a visual stimulus, or a tactile stimulus. Triggers can be determined be vehicle sensors, through wireless connections (or lack thereof), vehicle/user interfaces, and the like.

In one aspect, provided is an apparatus comprising a telematics unit. The apparatus can be installed in a vehicle. Such vehicles include, but are not limited to, personal and commercial automobiles, motorcycles, transport vehicles, watercraft, aircraft, and the like. For example, an entire fleet of a vehicle manufacturer's vehicles can be equipped with the apparatus. The apparatus 101 may be referred to herein as a telematics control unit (“TCU”) or as a vehicle telematics unit (“VTU”). Apparatus 101 can perform the methods disclosed herein in part and/or in their entireties, or may operate in conjunction with a centralized computer system to perform the methods disclosed herein.

All components of the telematics unit can be contained within a single box and controlled with a single core processing subsystem or can be comprised of components distributed throughout a vehicle. Each of the components of the apparatus can be separate subsystems of the vehicle, for example, a communications component such as a Satellite Digital Audio Radio Service (SDARS), or other satellite receiver, can be coupled with an entertainment system of the vehicle.

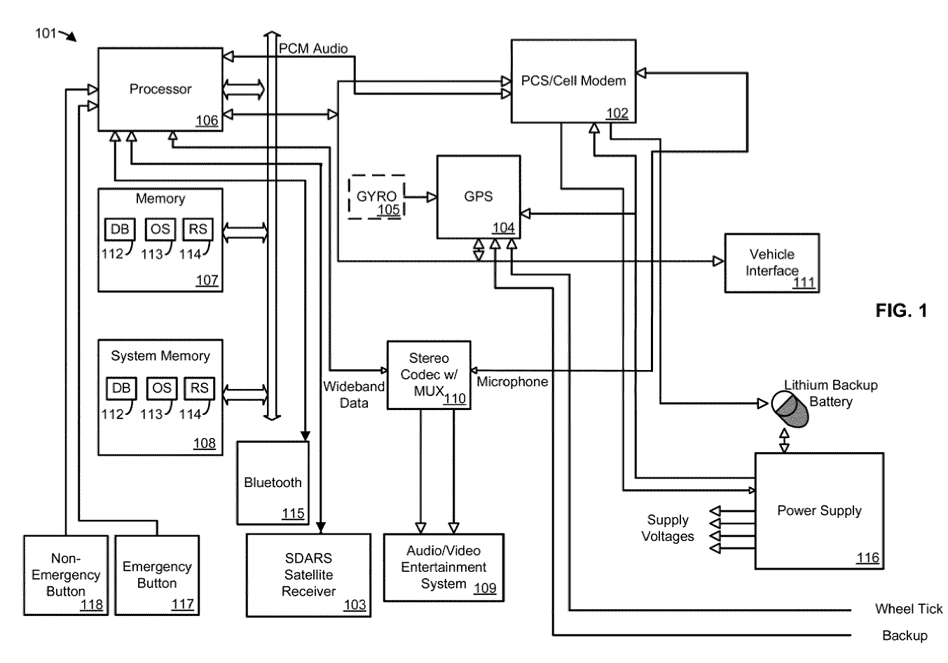

An exemplary apparatus 101 is illustrated in FIG. 1. This exemplary apparatus is only an example of an apparatus and is not intended to suggest any limitation as to the scope of use or functionality of operating architecture. Neither should the apparatus be necessarily interpreted as having any dependency or requirement relating to any one or combination of components illustrated in the exemplary apparatus. The apparatus 101 can comprise one or more communications components. Apparatus 101 illustrates communications components (modules) PCS/Cell Modem 102 and SDARS receiver 103. These components can be referred to as vehicle mounted transceivers when located in a vehicle. PCS/Cell Modem 102 can operate on any frequency available in the country of operation, including, but not limited to, the 850/1900 MHz cellular and PCS frequency allocations. The type of communications can include, but is not limited to GPRS, EDGE, UMTS, 1xRTT or EV-DO. The PCS/Cell Modem 102 can be a Wi-Fi or mobile Worldwide Interoperability for Microwave Access (WIMAX) implementation that can support operation on both licensed and unlicensed wireless frequencies. The apparatus 101 can comprise an SDARS receiver 103 or other satellite receiver. SDARS receiver 103 can utilize high powered satellites operating at, for example, 2.35 GHz to broadcast digital content to automobiles and some terrestrial receivers, generally demodulated for audio content, but can contain digital data streams.

PCS/Cell Modem 102 and SOARS receiver 103 can be used to update an onboard database 112 contained within the apparatus 101. Updating can be requested by the apparatus 101, or updating can occur automatically. For example, database updates can be performed using FM subcarrier, cellular data download, other satellite technologies, Wi-Fi and the like. SDARS data downloads can provide the most flexibility and lowest cost by pulling digital data from an existing receiver that exists for entertainment purposes. An SDARS data stream is not a channelized implementation (like AM or FM radio) but a broadband implementation that provides a single data stream that is separated into useful and applicable components.

GPS receiver 104 can receive position information from a constellation of satellites operated by the U.S. Department of Defense. Alternately, the GPS receiver 104 can be a GLONASS receiver operated by the Russian Federation Ministry of Defense, or any other positioning device capable of providing accurate location information (for example, LORAN, inertial navigation, and the like). GPS receiver 104 can contain additional logic, either software, hardware or both to receive the Wide Area Augmentation System (WAAS) signals, operated by the Federal Aviation Administration, to correct dithering errors and provide the most accurate location possible. Overall accuracy of the positioning equipment subsystem containing WAAS is generally in the two meter range. Optionally, the apparatus 101 can comprise a MEMS gyro 105 for measuring angular rates and wheel tick inputs for determining the exact position based on dead-reckoning techniques. This functionality is useful for determining accurate locations in metropolitan urban canyons, heavily tree-lined streets and tunnels.

One or more processors 106 can control the various components of the apparatus 101. Processor 106 can be coupled to removable/non-removable, volatile/non-volatile computer storage media. By way of example, FIG. 1 illustrates memory 107, coupled to the processor 106, which can provide non-volatile storage of computer code, computer readable instructions, data structures, program modules, and other data for the computer 101. For example and not meant to be limiting, memory 107 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

The processing of the disclosed systems and methods can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

Any number of program modules can be stored on the memory 107, including by way of example, an operating system 113 and software 114. Each of the operating system 113 and software 114 (or some combination thereof) can comprise elements of the programming and the software 114. Data can also be stored on the memory 107 in database 112. Database 112 can be any of one or more databases known in the art. Examples of such databases comprise, DB2®, Microsoft® Access, Microsoft® SQL Server, Oracle®, mySQL, PostgreSQL, and the like. The database 112 can be centralized or distributed across multiple systems. The software 114 can comprise telematics software and the data can comprise telematics data.

By way of example, the operating system 113 can be a Linux (Unix-like) operating system. One feature of Linux is that it includes a set of “C” programming language functions referred to as, “NDBM”. NDBM is an API for maintaining key/content pairs in a database which allows for quick access to relatively static information. NDBM functions use a simple hashing function to allow a programmer to store keys and data in data tables and rapidly retrieve them based upon the assigned key. A major consideration for an NDBM database is that it only stores simple data elements (bytes) and requires unique keys to address each entry in the database. NDBM functions provide a solution that is among the fastest and most scalable for small processors.

It is recognized that such programs and components reside at various times in different storage components of the apparatus 101, and are executed by the processor 106 of the apparatus 101. An implementation of reporting software 114 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

FIG. 1 illustrates system memory 108, coupled to the processor 106, which can comprise computer readable media in the form of volatile memory, such as random access memory (RAM, SDRAM, and the like), and/or non-volatile memory, such as read only memory (ROM). The system memory 108 typically contains data and/or program modules such as operating system 113 and software 114 that are immediately accessible to and/or are presently operated on by the processor 106. The operating system 113 can comprise a specialized task dispatcher, slicing available bandwidth among the necessary tasks at hand, including communications management, position determination and management, entertainment radio management, SDARS data demodulation and assessment, power control, and vehicle communications.

The processor 106 can control additional components within the apparatus 101 to allow for ease of integration into vehicle systems. The processor 106 can control power to the components within the apparatus 101, for example, shutting off GPS receiver 104 and SDARS receiver 103 when the vehicle is inactive, and alternately shutting off the PCS/Cell Modem 102 to conserve the vehicle battery when the vehicle is stationary for long periods of inactivity. The processor 106 can also control an audio/video entertainment subsystem 109 and comprise a stereo codec and multiplexer 110 for providing entertainment audio and video to the vehicle occupants, for providing wireless communications audio (PCS/Cell phone audio), speech recognition from the driver compartment for manipulating the SDARS receiver 103 and PCS/Cell Modem 102 phone dialing, and text to speech and pre-recorded audio for vehicle status annunciation.

Audio/video entertainment subsystem 109 can comprise a radio receiver, FM, AM, Satellite, Digital and the like. Audio/video entertainment subsystem 109 can comprise one or more media players. An example of a media player includes, but is not limited to, audio cassettes, compact discs, DVD's, Blu-ray, HD-DVDs, Mini-Discs, flash memory, portable audio players, hard disks, game systems, and the like. Audio/video entertainment subsystem 109 can comprise a user interface for controlling various functions. The user interface can comprise buttons, dials, and/or switches. In certain embodiments, the user interface can comprise a display screen. The display screen can be a touchscreen. The display screen can be used to provide information about the particular entertainment being delivered to an occupant, including, but not limited to Radio Data System (RDS) information, ID3 tag information, video, and various control functionality (such as next, previous, pause, etc. . . . ), websites, and the like. Audio/video entertainment subsystem 109 can utilize wired or wireless techniques to communicate to various consumer electronics including, but not limited to, cellular phones, laptops, PDAs, portable audio players (such as an iPod), and the like. Audio/video entertainment subsystem 109 can be controlled remotely through, for example, a wireless remote control, voice commands, and the like.

Data obtained and/or determined by processor 106 can be displayed to a vehicle occupant and/or transmitted to a remote processing center. This transmission can occur over a wired or a wireless network. For example, the transmission can utilize PCS/Cell Modem 102 to transmit the data. The data can be routed through the Internet where it can be accessed, displayed and manipulated.

The apparatus 101 can interface and monitor various vehicle systems and sensors to determine vehicle conditions. Apparatus 101 can interface with a vehicle through a vehicle interface 111. The vehicle interface 111 can include, but is not limited to, OBD (On Board Diagnostics) port, OBD-II port, CAN (Controller Area Network) port, and the like. The vehicle interface 111, allows the apparatus 101 to receive data indicative of vehicle performance, such as vehicle trouble codes, operating temperatures, operating pressures, speed, fuel air mixtures, oil quality, oil and coolant temperatures, wiper and light usage, mileage, break pad conditions, and any data obtained from any discrete sensor that contributes to the operation of the vehicle engine and drive-train computer. Additionally CAN interfacing can eliminate individual dedicated inputs to determine brake usage, backup status, and it can allow reading of onboard sensors in certain vehicle stability control modules providing gyro outputs, steering wheel position, accelerometer forces and the like for determining driving characteristics. The apparatus 101 can interface directly with a vehicle subsystem or a sensor, such as an accelerometer, gyroscope, airbag deployment computer, and the like. Data obtained, and processed data derived from, from the various vehicle systems and sensors can be transmitted to a central monitoring station via the PCS/Cell Modem 102.

Apparatus 101 can also interface with an onboard camera system, or sensor system, such as an OEM vehicle manufacturers may include as part of a back-up vision system, a park assist system, a night vision detection system, and the like. For example, a user may select a trigger, and corresponding trigger instructions, occurring when a camera system, or sensor system, detects an object within a predetermined proximity, or distance from, the vehicle containing apparatus 101.

Or, a user may select a trigger, such as an abnormally high reading from an accelerometer device on a vehicle. The high accelerometer reading could indicate either a collision for a vehicle in motion, or an attempted theft of a stationary vehicle. A vehicle's TCU 101 can process accelerometer data, from either an accelerometer contained in it, or an accelerometer device mounted external to it. Since a TCU 101 typically couples with a vehicle's onboard computer data bus, as well as a diagnostics bus (the diagnostic and onboard computer may be the same bus) A CAN bus, or similar bus is an example of a vehicle bus the TCU interfaces with.

The TCU can determine from diagnostic data and information from the bus that the vehicle is in motion. A vehicle in motion tends to encounter certain forces due to normal operating conditions, such as turning, braking, speeding up, etc. So, a user may select a threshold for trigger in a moving vehicle as a force value higher than forces that an accelerometer would detect under normal operation of the vehicle. For example, a moving vehicle may experience acceleration values up to approximately 1.0 g for a street driven vehicle, and perhaps up to 2.0-g for a vehicle in a race environment.

For the street driven vehicle, a user may select a trigger event as an accelerometer on the vehicle experiencing greater than approximately 0.9 g. Upon a TCU 101 determining that accelerometers coupled to it experience greater than 0.95 g, the TCU could perform the task of collecting image data from cameras, night vision sensors, and the like, and forwarding them via Multi Media Service (“MMS”) as a message, or file, to a centrally located TOC. The TOC could them store image files as they come in from the TCU that can be used in accident investigation, insurance investigation purposes, traffic study purposes, or other similar purpose.

In the scenario of a stationary vehicle, the TCU 101, which can distinguish between a stationary and moving vehicle based on GPS information in continuously processes, or diagnostic data it processes, such as, for example, vehicle speed. A user may select an accelerometer value less than the values encountered during normal operation as a trigger even for a stationary vehicle. For example, a vehicle may experience a lateral acceleration value of 0.5 g during normal operation, but a stationary car should not experience that high of an acceleration, even from forces due to wind gusts or an inadvertent passerby leaning on the vehicle. However, a bump in a parking lot by another vehicle in motion, or an attempt by a thief, or vandal, to smash a window of the vehicle would typically result in an onboard accelerometer sensing higher than the 0.5 g stationary threshold setting.

Thus, the TCU would perform the trigger instructions associated with a selected trigger of comparing values read from an onboard accelerometer with a predetermined threshold acceleration value and performing a task according to instructions associated with the selected trigger of collecting images from onboard cameras, or sensors, and transmitting the images via MMS over a communication network to a TOC for storage and later evaluation.

Instead of determining that an acceleration exceeded a predetermined threshold constitutes a trigger, other sensor's data, such as glass pressure sensors or opening of a door without the vehicle having received an unlock command from a key fob, from a wireless mobile device such as a cellular phone, or from a remotely located user, such as service personnel at a TOC location, could function as a trigger. Upon the occurrence of one of the triggering events, the TCU may perform trigger instructions associated in the with TCU detecting the occurrence of the triggering event, and if performing the triggering instructions determines that predetermined criteria are met, the TCU can perform the task steps of collecting and transmitting images based on the assumption that a thief, or vandal, has opened the door to the car. Thus, the collected and transmitted image files can provide evidence that identifies the thief and the environment during the attempted break in.

If a legitimate user of the vehicle opened the car after manually unlocking the door by inserting a traditional physical key into a lock and turning it, the part of the task instruction could cause the TOC to erase the received images from its server memory storage after a predetermined period (the user could select the predetermined time when selecting the trigger and task) upon receiving a message from the TCU that it has detected the presence of a legitimate key fob. Alternatively, the selected task may before the TCU, or TOC, to initiate a stimulus, such as a ringtone, a vibration, a chime, a flashing light, etc, to a user's personal computer or mobile wireless device. The stimulus may alert the user of the computer or device to check his e-mail account to view the images and confirm that he indeed drove the vehicle while TCU uploaded the images, as opposed to a thief. Or, the stimulus may instruct the legitimate user to view a web site that hosts the images, and that provides an interface for confirming he was driving the car rather than a thief.

Other selected triggers may initiate the performing of trigger instructions and corresponding task instructions at a TOC. For example, if a vehicle's TCU determines from its normal monitoring of vehicle information from the vehicle information bus, such as a CAN bus, that values for the fuel level, oil level, engine temperature, tire air pressure, or other similar operating parameters fall outside a predetermined range, the TOC can initiate the sending of an alert to a computer device, or a wireless communication device, like a cellular phone, or a computer device coupled to a cellular communication device.

For example, if a teenage girl drives her father's car, the car's TCU may constantly transmits diagnostic data, and other information retrieved from the vehicle's CAN bus to the TOC. If the TOC receives and processes the information from the TCU, and determines that the fuel level in the vehicle has fallen to a predetermined level (i.e., the determining that the fuel level is low would be a triggering event), the TOC could then generate an alert message and transmit it to girl's father's cellphone. The alert message could be a phone call, an e-mail, an SMS message, etc. The generating of the alert message and initiating the transmission of it to the father's cell phone would constitute the task associated with the selected trigger (fuel level dropping below the threshold). When the TOC determines that the fuel threshold has been reached, it performs the associated task instructions to carry out the corresponding task.

Communication with a vehicle driver can be through an infotainment (radio) head (not shown) or other display device (not shown). More than one display device can be used. Examples of display devices include, but are not limited to, a monitor, an LCD (Liquid Crystal Display), a projector, and the like.

The apparatus 101 can receive power from power supply 116. The power supply can have many unique features necessary for correct operation within the automotive environment. One mode is to supple a small amount of power (typically less than 100 microamps) to at least one master controller that can control all the other power buses inside of the VTU 101. In an exemplary system, a low power low dropout linear regulator supplies this power to PCS/Cellular modem 102. This provides the static power to maintain internal functions so that it can await external user push-button inputs or await CAN activity via vehicle interface 111. Upon receipt of an external stimulus via either a manual push button or CAN activity, the processor contained within the PCS/Cellular modem 102 can control the power supply 116 to activate other functions within the VTU 101, such as GPS 104/GYRO 105, Processor 106/Memory 107 and 108, SDARS receiver 103, audio/video entertainment system 109, audio codec mux 110, and any other peripheral within the VTU 101 that does not require standby power.

In an exemplary system, there can be a plurality of power supply states. One state can be a state of full power and operation, selected when the vehicle is operating. Another state can be a full power relying on battery backup. It can be desirable to turn off the GPS and any other non-communication related subsystem while operating on the back-up batteries. Another state can be when the vehicle has been shut off recently, perhaps within the last 30 days, and the system maintains communications with a two-way wireless network for various auxiliary services like remote door unlocking and location determination messages. After the recent shut down period, it is desirable to conserve the vehicle battery by turning off almost all power except the absolute minimum in order to maintain system time of day clocks and other functions, waiting to be awakened on CAN activity. Additional power states are contemplated, such as a low power wakeup to check for network messages, but these are nonessential features to the operation of the VTU.

Normal operation can comprise, for example, the PCS/Cellular modem 102 waiting for an emergency push button, key-press, or CAN activity. Once either is detected, the PCS/Cellular modem 102 can awaken and enable the power supply 116 as required. Shutdown can be similar wherein a first level shutdown turns off everything except the PCS/Cellular modem 102, for example. The PCS/Cellular modem 102 can maintain wireless network contact during this state of operation. The VTU 101 can operate normally in the state when the vehicle is turned off. If the vehicle is off for an extended period of time, perhaps over a vacation etc., the PCS/Cellular modem 102 can be dropped to a very low power state where it no longer maintains contact with the wireless network.

Additionally, in FIG. 1, subsystems can include a BlueTooth transceiver 115 that can be provided to interface with devices such as phones, headsets, music players, and telematics user interfaces. The apparatus can comprise one or more user inputs, such as emergency button 117 and non-emergency button 118. Emergency button 117 can be coupled to the processor 106. The emergency button 117 can be located in a vehicle cockpit and activated an occupant of the vehicle. Activation of the emergency button 117 can cause processor 106 to initiate a voice and data connection from the vehicle to a central monitoring station, also referred to as a remote call center. Data such as GPS location and occupant personal information can be transmitted to the call center. The voice connection permits two way voice communication between a vehicle occupant and a call center operator. The call center operator can have local emergency responders dispatched to the vehicle based on the data received. In another embodiment, the connections are made from the vehicle to an emergency responder center.

One or more non-emergency buttons 118 can be coupled to the processor 106. One or more non-emergency buttons 118 can be located in a vehicle cockpit and activated by an occupant of the vehicle. Activation of the one or more non-emergency buttons 118 can cause processor 106 to initiate a voice and data connection from the vehicle to a remote call center. Data such as GPS location and occupant personal information can be transmitted to the call center. The voice connection permits two way voice communications between a vehicle occupant and a call center operator. The call center operator can provide location based services to the vehicle occupant based on the data received and the vehicle occupant's desires. For example, a button can provide a vehicle occupant with a link to roadside assistance services such as towing, spare tire changing, refueling, and the like. In another embodiment, a button can provide a vehicle occupant with concierge-type services, such as local restaurants, their locations, and contact information; local service providers their locations, and contact information; travel related information such as flight and train schedules; and the like.

For any voice communication made through the VTU 101, text-to-speech algorithms can be used so as to convey predetermined messages in addition to or in place of a vehicle occupant speaking. This allows for communication when the vehicle occupant is unable or unwilling to communicate vocally.

In an aspect, apparatus 101 can be coupled to a telematics user interface located remote from the apparatus. For example, the telematics user interface can be located in the cockpit of a vehicle in view of vehicle occupants while the apparatus 101 is located under the dashboard, behind a kick panel, in the engine compartment, in the trunk, or generally out of sight of vehicle occupants.

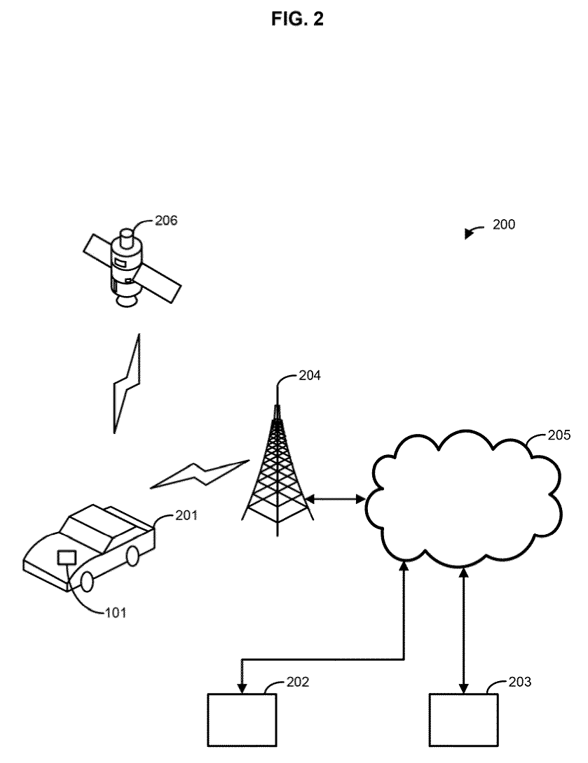

FIG. 2 is a block diagram illustrating an exemplary vehicle interaction system 200 showing network connectivity between various components. The vehicle interaction system 200 can comprise a VTU 101 located in a motor vehicle 201. The vehicle interaction system 200 can comprise a central station 202. The distributed computing model has no single point of complete system failure, thus minimizing vehicle interaction system 200 downtime. In an embodiment, central station 202 can communicate through an existing communications network (e.g., wireless towers 204 and communications network 205). Station 202 may comprise a computer server at a telematics operations center (“TOC”), or generally a computer server logically centrally located with respect to communications network 205. Vehicle interaction system 200 can comprise at least one satellite 206 from which a satellite radio provider can transmit a signal. These signals can be received by a satellite radio in the vehicle 201. In an aspect, the system can comprise one or more GPS satellites for determining vehicle 201 position.

The vehicle interaction system 200 can comprise a plurality of users 203 (consumers, stimulus providers, and the like) which can access vehicle interaction system 200 using a personal computer (PC) or other such computing device. Examples of stimulus providers can comprise, for example, ring tone providers, sound clip providers, movie providers, movie clip providers, wallpaper providers, vehicle interaction profile providers, and the like. A vehicle interaction profile can be, for example, a plurality of pre-defined tasks, triggers, and stimuli. For example, a predefined lighting profile, wherein the vehicle interior light flashes when the vehicle is unlocked and remains steady for a predefined time period when the vehicle is locked. For simplicity, FIG. 2 shows only one user 203. The users 203 can connect to the vehicle interaction system 200 via the communications network 205. In an embodiment, communications network 205 can comprise the Internet.

The vehicle interaction system 200 can comprise a central station 202 which can comprise one or more central station servers. In some aspects, one or more central station servers can serve as the “back-bone” (i.e., system processing) of the present vehicle interaction system 200. One skilled in the art will appreciate that vehicle interaction system 200 can utilize servers (and databases) physically located on one or more computers and at one or more locations. Central station server can comprise software code logic that is responsible for handling tasks such as downloading stimuli, downloading vehicle interaction profiles, financial transactions, purchasing history, purchase preferences, data interpretations, statistics processing, data preparation, data compression, report generation, and the like. In an embodiment of the present vehicle interaction system 200, central station servers can have access to a repository database which can be a central store for all information and vehicle interaction data within the vehicle interaction system 200 (e.g., executable code, subscriber information such as login names, passwords, etc., vehicle and demographics related data, tasks, triggers, stimuli, vehicle interaction profiles). Central station servers can also provide a “front-end” for the vehicle interaction system 200. That is, a central station server can comprise a Web server for providing a Web site which sends out Web pages in response to requests from remote browsers (i.e., users 203). More specifically, a central station server can provide a graphical user interface (GUI) “front-end” to users 203 of the vehicle interaction system 200 in the form of Web pages. These Web pages, when sent to the user PC (or the like), can result in GUI screens being displayed. Users can configure vehicle interaction parameters from the web site, or from inside the vehicle.

As described above, VTU 101 can communicate with one or more computers, either through direct wireless communication and/or through a network such as the Internet. Such communication can facilitate data transfer, voice communication, and the like. One skilled in the art will appreciate that what follows is a functional description of an exemplary operating environment and that functions can be performed by software, by hardware, or by any combination of software and hardware.

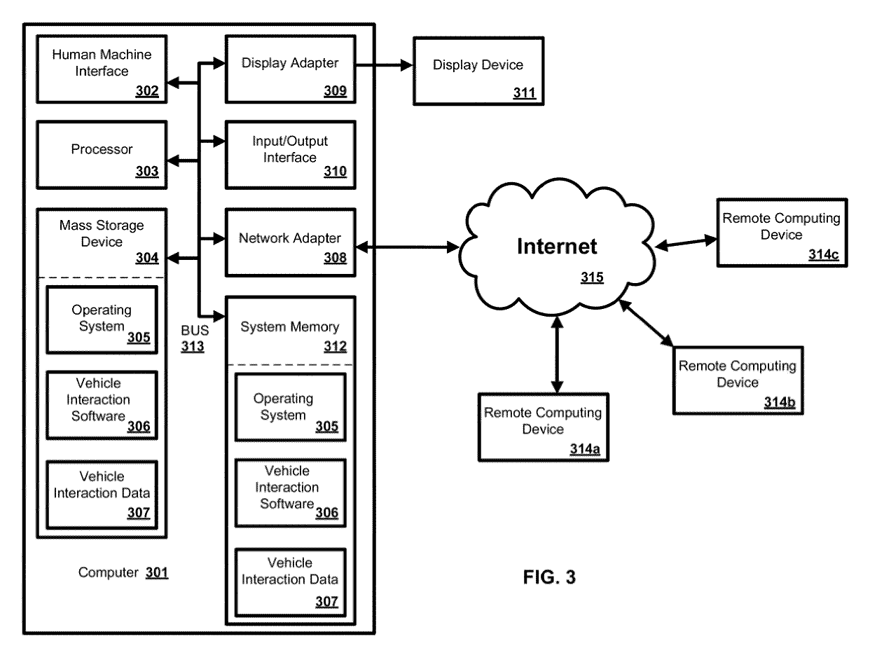

FIG. 3 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

In another aspect, the methods and systems can be described in the general context of computer instructions, such as program modules, being executed by a computer. Generally, program modules comprise routines, programs, objects, components, data structures, etc. that perform particular tasks or implement particular abstract data types. The methods and systems can also be practiced in distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 301. The components of the computer 301 can comprise, but are not limited to, one or more processors or processing units 303, a system memory 312, and a system bus 313 that couples various system components including the processor 303 to the system memory 312.

The system bus 313 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, PCI-Express bus. Universal Serial Bus (USB), and the like. The bus 313, and all buses specified in this description can also be implemented over a wired or wireless network connection and each of the subsystems, including the processor 303, a mass storage device 304, an operating system 305, telematics software 306, vehicle interaction data 307, a network adapter (or communications interface) 308, system memory 312, an Input/Output Interface 310, a display adapter 309, a display device 311, and a human machine interface 302, can be contained within one or more remote computing devices 314a,b,c at physically separate locations, connected through buses of this form, in effect implementing a fully distributed system. In one aspect, a remote computing device can be a VTU 101.

The computer 301 typically comprises a variety of computer readable media. Exemplary readable media can be any available media that is accessible by the computer 301 and comprises, for example and not meant to be limiting, both volatile and non-volatile media, removable and non-removable media. The system memory 312 comprises computer readable media in the form of volatile memory, such as random access memory (RAM), and/or non-volatile memory, such as read only memory (ROM). The system memory 312 typically contains data such as vehicle interaction data 307 and/or program modules such as operating system 305 and vehicle interaction data processing software 306 that are immediately accessible to and/or are presently operated on by the processing unit 303. Vehicle interaction data 307 can comprise any data generated by, generated for, received from, or sent to the VTU.

In another aspect, the computer 301 can also comprise other removable/non-removable, volatile/non-volatile computer storage media. By way of example, FIG. 3 illustrates a mass storage device 304 which can provide non-volatile storage of computer code, computer readable instructions, data structures, program modules, and other data for the computer 301. For example and not meant to be limiting, a mass storage device 304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 304, including by way of example, an operating system 305 and vehicle interaction data processing software 306. Each of the operating system 305 and vehicle interaction data processing software 306 (or some combination thereof) can comprise elements of the programming and the vehicle interaction data processing software 306. Vehicle interaction data 307 can also be stored on the mass storage device 304. Vehicle interaction data 307 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 301 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 303 via a human machine interface 302 that is coupled to the system bus 313, but can be connected by other interface and bus structures, such as a parallel port, game port, an IEEE 1394 Port (also known as a Firewire port), a serial port, or a universal serial bus (USB).

In yet another aspect, a display device 311 can also be connected to the system bus 313 via an interface, such as a display adapter 309. It is contemplated that the computer 301 can have more than one display adapter 309 and the computer 301 can have more than one display device 311. For example, a display device can be a monitor, an LCD (Liquid Crystal Display), or a projector. In addition to the display device 311, other output peripheral devices can comprise components such as speakers (not shown) and a printer (not shown) which can be connected to the computer 301 via Input/Output Interface 310.

The computer 301 can operate in a networked environment using logical connections to one or more remote computing devices 314a,b,c. By way of example, a remote computing device can be a personal computer, portable computer, a server, a router, a network computer, a VTU 101, a PDA, a cellular phone, a “smart” phone, a wireless communications enabled key fob, a peer device or other common network node, and so on. Logical connections between the computer 301 and a remote computing device 314a,b,c can be made via a local area network (LAN) and a general wide area network (WAN). Such network connections can be through a network adapter 308: A network adapter 308 can be implemented in both wired and wireless environments. Such networking environments are conventional and commonplace in offices, enterprise-wide computer networks, intranets, and the Internet 315. In one aspect, the remote computing device 314a,b,c can be one or more VTU 101's.

For purposes of illustration, application programs and other executable program components such as the operating system 305 are illustrated herein as discrete blocks, although it is recognized that such programs and components reside at various times in different storage components of the computing device 301, and are executed by the data processor(s) of the computer. An implementation of vehicle interaction data processing software 306 can be stored on or transmitted across some form of computer readable media. Computer readable media can be any available media that can be accessed by a computer. By way of example and not meant to be limiting, computer readable media can comprise “computer storage media” and “communications media.” “Computer storage media”comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

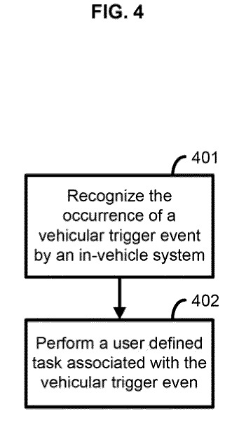

In an aspect, illustrated in FIG. 4, provided are methods for vehicle interaction, comprising recognizing the occurrence of a vehicular trigger event by an in-vehicle system at 401 and performing a user defined task associated with the vehicular trigger event at 402. An in-vehicle device, such as a TCU/VCU 101 can perform the user defined task associated with the trigger event. Alternatively, a computer device located remotely from the vehicle can perform instructions that carry out the task. An example of the computer device is a TOC server located at a telematics services provider central location. Or, another example of a computer device carrying out task instructions corresponding to the occurrence of one, or more, events associated with a particular selected trigger event may be a wireless smartphone. Recognizing the occurrence of a vehicular trigger event by an in-vehicle system can comprise, for example, monitoring a vehicle bus to determine a vehicle sensor status, determining, or detecting, the existence of a wireless connection, for example, to a phone, Bluetooth key fob, and the like, or determining, or detecting, the presence of, and ability to connect to, a wireless network, such as, for example, a cellular telephone network, a Bluetooth network, a Wi-Fi hotspot, and detecting interaction between the user and a vehicle interface, and the like.

The vehicular trigger event can be one, or more of, a location based trigger, a user initiated trigger, or a vehicle condition trigger. The location based trigger can be, for example, one or more of a user approaching or leaving the vehicle, the vehicle approaching a landmark or other point of interest, entering or exiting a geo-fence, and the like. The user initiated trigger can be, for example, one or more of a user pressing a button, flipping a switch, opening/closing a door, trunk, hatch, window, hood, fuel door, etc. . . . buckling or unbuckling a seat belt, exceeding a speed threshold, changing gears, and the like. The vehicle condition trigger can be, for example, one or more of, low fuel, low oil, low coolant, temperature threshold exceeded, maintenance due, tire pressure, and the like.

The user defined task can comprise a user selected stimulus associated with a user selected vehicular trigger event. The user selected stimulus can be one or more of, an audio stimulus, a visual stimulus, or a tactile stimulus. The audio stimulus can be, for example, one or more of, a ring tone, a voice, a sound clip, a tone, a beep and the like. A visual stimulus can be one or more of, a light, an image, a wallpaper, an animation, a movie clip, and the like. A tactile stimulus can be one or more of, vibrating the seat, moving the seat, moving the steering wheel, activating/deactivating seat heaters, activating/deactivating climate control, and the like.

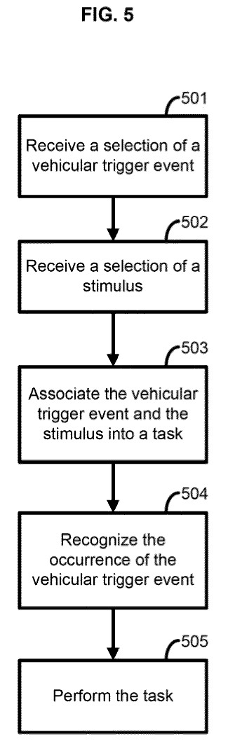

In another aspect, illustrated in FIG. 5, provided are methods for vehicle interaction, comprising receiving a selection of a vehicular trigger event at 501, receiving a selection of a stimulus at 502, associating the vehicular trigger event with the stimulus, or a task at 503, recognizing the occurrence of the vehicular trigger event at 504, and performing the stimulus or task at 505.

The vehicular trigger event can be one or more of, a location based trigger, a user initiated trigger, or a vehicle condition trigger. The location based trigger can be, for example, one or more of a user approaching or leaving the vehicle, the vehicle approaching a landmark or other point of interest, entering or exiting a geo-fence, and the like. The user initiated trigger can be, for example, one or more of a user pressing a button, flipping a switch, opening/closing a door, trunk, hatch, window, hood, fuel door, etc. . . . buckling or unbuckling a seat belt, exceeding a speed threshold, changing gears, and the like. The vehicle condition trigger can be, for example, one or more of, low fuel, low oil, low coolant, temperature threshold exceeded, maintenance due, tire pressure, and the like.

The user task can comprise a stimulus associated with a vehicular trigger event. The stimulus can be one or more of, an audio stimulus, a visual stimulus, or a tactile stimulus. The audio stimulus can be, for example, one or more of, a ring tone, a voice, a sound clip, a tone, a beep and the like. A visual stimulus can be one or more of, a light, an image, a wallpaper, an animation, a movie clip, and the like. A tactile stimulus can be one or more of, vibrating the seat, moving the seat, moving the steering wheel, activating/deactivating seat heaters, activating/deactivating climate control, and the like.

Performing the task can comprise presenting the stimulus to the user. The methods can further comprise receiving a stimulus uploaded by a user. The user can upload the stimulus through, for example, a website, a wireless link from a handheld electronic device, a portable storage device, an email, and the like.

In addition, performance of the task at step 505 may include presenting a different predetermined stimulus based on an algorithm that calculates a result based on a variety of factors. For example, an onboard telematics unit may transmit a message to a predetermined location, or device, for example a driver's home computer, or his personal smartphone, or other wireless device, informing a family member of the driver when the driver will arrive home. In performing task 505, the telematics unit may acquire real time traffic information, its location, the location of the driver's home, and compute the driver's fastest route home. Then, upon occurrence of a triggering event, for example the vehicle passing a predetermined landmark, or location, based on GPS location messaging, the telematics unit computes the preferred route to arrive in the shortest amount of time; instructs, displays, or otherwise informs and guides the driver along the route; and transmits a message via a wireless communication link to the driver's home computer, or other predetermined device. The message could include an audio message that informs a user of the predetermined device of the estimated time of arrival of the driver based on the driver following the calculated route.

The telematics unit may transmit a message to another device via a variety of ways. These ways may include sending an e-mail message to a contact's email address, SMS number or address, or a phone message to a phone number, wherein the contact information is retrieved from a contact list, either from a portable device coupled to the telematics device, that the driver, or other user, has previously stored in the telematics unit. The contact information may correspond to the driver's destination address, for example, but could be any other address or location chosen by the driver, owner, or other user of the vehicle. A telematics unit may also transmit a message via a datagram sent to a different type of application, or device. For example, a telematics device in a vehicle driven by a husband might send a message in a datagram to a ‘Family Locator’ application that the wife has on her wireless phone, or similar device. The application on the wife's device could then interpret the message in the datagram and display the textual message ‘John will arrive home in approximately thirteen minutes.’

Other services that can be triggered include business or residential phone number looked-up in real-time that corresponds to a selected navigation destination address.

Method 500 may also use pre-configured contact phone number/email-address/SMS for contact that corresponds to selected navigation destination. (i.e. navigation to home “Home” is configured to SMS wife's cell phone).

Contact method for these can be configured for any combination of SMS, email, recorded voice call or live voice call on web-portal or locally on system in car prior to navigation or real-time during navigation.

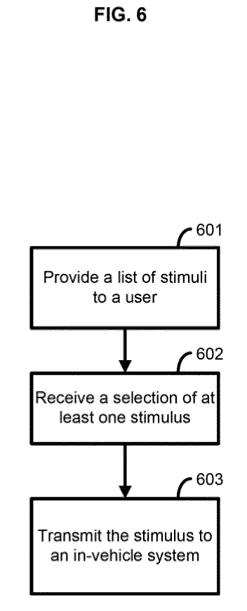

In another aspect, illustrated in FIG. 6, provided are methods for vehicle interaction, comprising providing a list of stimuli to a user at 601, perhaps at a personal computer or wireless device located remotely from a central computer server and remotely from the vehicle, receiving a selection of at least one stimulus at 602, and transmitting a message including an indication of which stimulus was selected, and perhaps instructions on how to perform the stimulus, to an in-vehicle system at 603.

The list of stimuli can comprise one or more of an audio stimulus, a visual stimulus, or a tactile stimulus. The audio stimulus can be, for example, one or more of, a ring tone, a voice, a sound clip, a tone, a beep and the like. A visual stimulus can be one or more of, a light, an image, a wallpaper, an animation, a movie clip, and the like. A tactile stimulus can be one or more of, vibrating the seat, moving the seat, moving the steering wheel, activating/deactivating seat heaters, activating/deactivating climate control, and the like.

The methods can further comprise receiving a stimulus, or stimulus instructions, uploaded by a user and adding the uploaded stimulus instructions to the list of stimuli. The user can upload the stimulus, or instructions, through, for example, a website, a wireless link from a handheld electronic device, a portable storage device, an email, and the like.

In an aspect, the methods can further comprise receiving a selection of a vehicular trigger event, associating the vehicular trigger event and a selected stimulus into a task, and transmitting the task to an in-vehicle system.

The vehicular trigger event can be one or more of, a location based trigger, a user initiated trigger, or a vehicle condition trigger. The location based trigger can be, for example, one or more of a user approaching or leaving the vehicle, the vehicle approaching a landmark or other point of interest, entering or exiting a geo-fence, and the like. The user initiated trigger can be, for example, one or more of a user pressing a button, flipping a switch, opening/closing a door, trunk, hatch, window, hood, fuel door, etc. . . . buckling or unbuckling a seat belt, exceeding a speed threshold, changing gears, and the like. The vehicle condition trigger can be, for example, one or more of, low fuel, low oil, low coolant, temperature threshold exceeded, maintenance due, tire pressure, and the like. The algorithm that may be invoked at step 505 may evaluate other factors in addition to real time traffic, such as, for example, real-time weather information, time of day, historical travel time on same route, speed limits, and road types and conditions, etc.

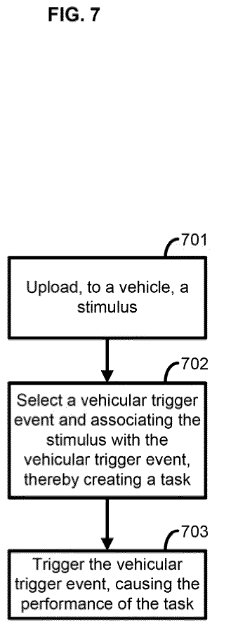

In another aspect, illustrated in FIG. 7, provided are methods for vehicle interaction, comprising uploading, to a vehicle, a stimulus at 701, selecting a vehicular trigger event and associating the stimulus with the vehicular trigger event, thereby creating a task at 702, and triggering the vehicular trigger event, causing the performance of the task at 703.

The stimulus can be one or more of, an audio stimulus, a visual stimulus, or a tactile stimulus. The audio stimulus can be, for example, one or more of, a ring tone, a voice, a sound clip, a tone, a beep and the like. A visual stimulus can be one or more of, a light, an image, a wallpaper, an animation, a movie clip, and the like. A tactile stimulus can be one or more of, vibrating the seat, moving the seat, moving the steering wheel, activating/deactivating seat heaters, activating/deactivating climate control, and the like. The vehicular trigger event can be one or more of, a location based trigger, a user initiated trigger, or a vehicle condition trigger. The location based trigger can be, for example, one or more of a user approaching or leaving the vehicle, the vehicle approaching a landmark or other point of interest, entering or exiting a geo-fence, and the like. The user initiated trigger can be, for example, one or more of a user pressing a button, flipping a switch, opening/closing a door, trunk, hatch, window, hood, fuel door, etc. . . . buckling or unbuckling a seat belt, exceeding a speed threshold, changing gears, and the like. The vehicle condition trigger can be, for example, one or more of, low fuel, low oil, low coolant, temperature threshold exceeded, maintenance due, tire pressure, and the like. The task can comprise a stimulus associated with a vehicular trigger event. For example, a user can perform the methods through an in-vehicle display, a website, over the phone, and the like.

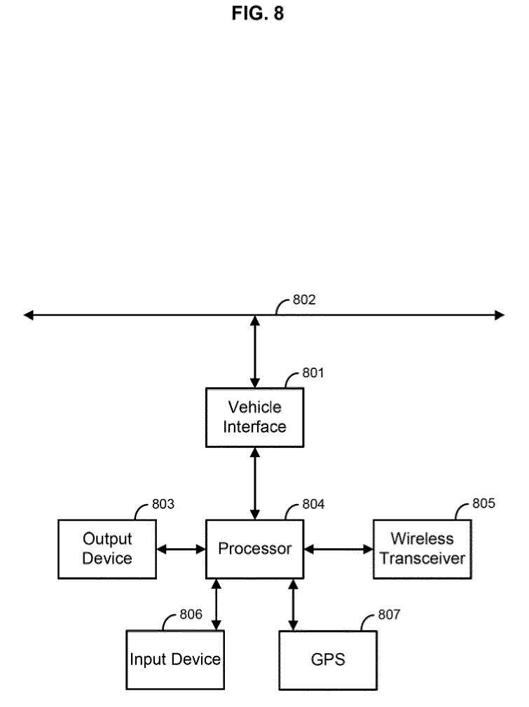

In a further aspect, illustrated in FIG. 8, provided is an apparatus for vehicle interaction, comprising a vehicle interface 801, coupled to a vehicle bus 802, wherein the vehicle interface is configured to receive vehicular trigger events through the vehicle bus 802, an output device 803, wherein the output device 803 is configured to provide a stimulus to a user, and a processor 804, coupled to the vehicle interface 801 and the output device 803, wherein the processor 804 is configured for receiving vehicular trigger events from the vehicle interface 801, for determining if the vehicular trigger event corresponds to a user defined task, and for providing a stimulus corresponding to the task to the user.

The apparatus can further comprise a wireless transceiver 805, coupled to the processor 804, configured for receiving a stimulus. The wireless transceiver 805 can be further configured for receiving a user defined task. The apparatus can further comprise an input device 806 coupled to the processor 804 and configured for receiving a selection of a stimulus and for receiving a selection of a vehicular trigger event. The apparatus can further comprise a GPS 807 coupled to the processor 804.

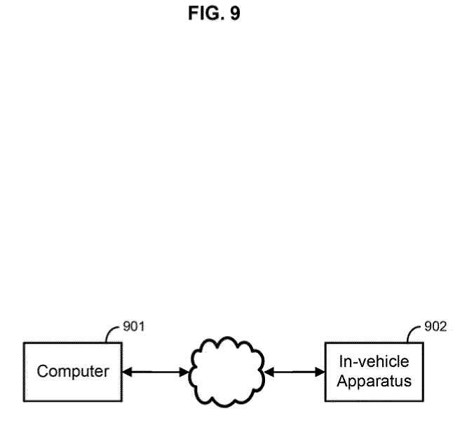

In another aspect, illustrated in FIG. 9, provided is a system for vehicle interaction, comprising a computer 901, configured for providing a list of stimuli to a user, for receiving a selection of at least one stimulus, and for transmitting the stimulus to an in-vehicle apparatus, and an in-vehicle apparatus 902 configured for receiving the stimulus and presenting the stimulus to a user upon occurrence of a vehicular trigger event.

The list of stimuli comprises one or more of an audio stimulus, a visual stimulus, or a tactile stimulus. The audio stimulus can be, for example, one or more of, a ring tone, a voice, a sound clip, a tone, a beep and the like. A visual stimulus can be one or more of, a light, an image, a wallpaper, an animation, a movie clip, and the like. A tactile stimulus can be one or more of, vibrating the seat, moving the seat, moving the steering wheel, activating/deactivating seat heaters, activating/deactivating climate control, and the like.

The computer 901 can be further configured for receiving a stimulus uploaded by a user and adding the uploaded stimulus to the list of stimuli. The user can upload the stimulus through, for example, a website, a wireless link from a handheld electronic device, a portable storage device, an email, and the like.

The computer 901 can be further configured for receiving a selection of a vehicular trigger event, associating the vehicular trigger event and the selected at least one stimulus into a task, and transmitting the task to the in-vehicle apparatus. For example, a user can configure a task through a website and have the task transmitted to the in-vehicle apparatus 902.

The vehicular trigger event can comprise one or more of a location based trigger, a user initiated trigger, or a vehicle condition trigger. The location based trigger can be, for example, one or more of a user approaching or leaving the vehicle, the vehicle approaching a landmark or other point of interest, entering or exiting a geo-fence, and the like. The user initiated trigger can be, for example, one or more of a user pressing a button, nipping a switch, opening/closing a door, trunk, hatch, window, hood, fuel door, etc. . . . buckling or unbuckling a seat belt, exceeding a speed threshold, changing gears, and the like. The vehicle condition trigger can be, for example, one or more of, low fuel, low oil, low coolant, temperature threshold exceeded, maintenance due, tire pressure, and the like.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method, comprising:
receiving a trigger selection associated with a trigger criterion or associated with trigger criteria;
receiving an action selection for association with the selected trigger,
associating with the selected trigger action instructions for performing the selected action when the selected trigger occurs;
determining that a trigger event corresponding to the selected trigger has occurred; and
initiating the performance of the action instructions.

2. The method of claim 1, wherein a telematics operations center server performs the steps of claim 1 in response to receiving a trigger occurrence message from a vehicle's telematics control unit.

3. The method of claim 1 wherein a telematics control unit in a vehicle performs the steps of claim 1.

4. The method of claim 3 wherein the selected trigger is the exceeding of a predetermined acceleration threshold criterion value by a value generated from an accelerometer integrated in a vehicle.

5. The method of claim 4 wherein the action instructions associated with the selected trigger include computer commands that cause the telematics control unit to collect image information from cameras integrated with the vehicle and to transmit the camera image information from the telematics control unit to a device located remote from the vehicle.

6. The method of claim 2 wherein the action includes searching a table indexed on identifiers associated with a plurality of vehicles and initiating performing of instructions associated in the table with an identifier corresponding to the vehicle.

7. A method, comprising:
receiving vehicle information at a vehicle's telematics control unit apparatus,
comparing a predetermined portion of the vehicle information to a trigger criterion or trigger criteria;
determining that a trigger event has occurred by determining that the predetermined portion of the vehicle information satisfies the trigger criterion or criteria; and
initiating the performance of predetermined action instructions that correspond to occurrence of the trigger event.

8. The method of claim 7 wherein the vehicle information is received from a CAN bus of the vehicle.

9. The method of claim 7 wherein the predetermined portion of the vehicle information is a diagnostic trouble code.

10. The method of claim 7 wherein the predetermined portion of the vehicle information includes vehicle information corresponding to one, or more, operational performance parameters.

11. The method of claim 10 wherein the operational performance parameters include one, or more of, tire pressure, fuel tank level, oil level, engine temperature, current transmission gear, tire pressure, engine speed, door lock status, seat belt usage status, geographical location of the vehicle, vehicle acceleration, engine revolutions, and engine exhaust composition.

12. The method of claim 7 wherein the telematics control unit derives the vehicle information from vehicle information it receives and compares the derived vehicle information, instead of the received vehicle information, to the trigger criterion or criteria.

13. The method of claim 12 wherein the telematics control unit derives an odometer value from location information received from a global positioning satellite circuit.

14. The method of claim 7 wherein the action instructions include:
instructing a telematics central server to look up information corresponding to an identifier associated with the telematics control unit in a database;
instructing the telematics central server to determine a selected user device associated with the identifier in the database; and
instructing the telematics central server to transmit a command to a user device to alert a user of the user device that the trigger event occurred.

15. A computer device, comprising:
a processor configured to perform the steps of receiving a vehicle's vehicle information, comparing a predetermined portion of the vehicle information to a trigger criterion or trigger criteria; determining that a trigger event has occurred by determining that the predetermined portion of the vehicle information satisfies the trigger criterion or criteria; and initiating the performance of predetermined action instructions that correspond to occurrence of the trigger event;
a memory for storing the trigger selection, the associated trigger criterion, or criteria, and corresponding action instructions; and
an interface coupled to a communication network for receiving and transmitting selected trigger information, selected action information, and vehicle information.

16. The computer device of claim 15 wherein the computer device is coupled to a CAN bus of the vehicle.

17. The computer device of claim 15 wherein the computer device is a wireless communication device that communicates with a telematics system via a wireless communication network.

18. The computer device of claim 15 wherein the wireless communication device is a cellular smart phone.

19. The computer device of claim 17 wherein the computer device is configured to receive vehicle information transmitted from a vehicle's telematics control unit and configured to perform a stimulus when a trigger event occurs.

20. The computer device of claim 15 wherein the computer device is a vehicle's telematics control unit that performs the action of transmitting an instruction to a user device remote from the vehicle to alert a user of the user device that the trigger event occurred, and that performs the action of transmitting an instruction to the user device to communicate to the user of the user device the extent to which the vehicle information did not satisfy the trigger criterion, or trigger criteria.
